(19) United States
(12) Patent Application Publication
(10) Pub. No.: US 2026/0235423 A1
(43) Pub. Date: Aug. 13, 2026

(54) AMMONIA FLOW RATE EVALUATION SYSTEM, AMMONIA FUEL UTILIZATION DEVICE, AND AMMONIA FLOW RATE EVALUATION METHOD

(71) Applicant: IHI Corporation, Tokyo (JP)

(72) Inventor: Hiroaki OHARA, Tokyo (JP)

(73) Assignee: IHI Corporation, Tokyo (JP)

(21) Appl. No.: 19/633,112

(22) Filed: Mar. 30, 2026

Related U.S. Application Data
(63) Continuation of application No. PCT/JP2025/004698, filed on Feb. 13, 2025.

(30) Foreign Application Priority Data
Feb. 29, 2024 (JP) 2024-030018

(51) Int. Cl. G01F 1/00; B01D 53/14; F23N 1/00

(52) U.S. Cl. CPC G01F 1/00; B01D 53/14; F23N 1/00

(57) ABSTRACT

An ammonia flow rate evaluation system includes: a first measurement unit to which a measurement target substance containing gaseous ammonia is supplied; a second measurement unit positioned downstream of the first measurement unit in a flow direction of the measurement target substance; and an ammonia absorption unit having an ammonia absorbent that absorbs ammonia in the measurement target substance, the ammonia absorption unit being installed between the first measurement unit and the second measurement unit and connected to the first measurement unit and the second measurement unit. The first measurement unit measures a pre-ammonia-absorption flow rate, the ammonia absorption unit uses the ammonia absorbent to absorb and remove ammonia from the measurement target substance that has passed through the first measurement unit, and the second measurement unit measures a post-ammonia-absorption flow rate.

### CROSS-REFERENCE TO RELATED APPLICATIONS

This application is a continuation application of International Application No. PCT/JP 2025/004698, filed on Feb. 13, 2025, which claims priority to Japanese Patent Application No. 2024-030018, filed on Feb. 29, 2024, the entire contents of which are incorporated by reference herein.

### BACKGROUND

### 1. Technical Field

The present disclosure relates to an ammonia flow rate evaluation system, an ammonia fuel utilization device, and an ammonia flow rate evaluation method.

### 2. Description of the Related Art

In recent years, methods of utilizing ammonia, which is considered a renewable energy source, as fuel have been studied. In combustion devices that burn ammonia, ammonia is stored in a storage tank or container and supplied through a fuel supply line (pipe). At that time, it is necessary to replace the residual gas in the fuel supply line with ammonia when filling fuel. Therefore, it is required to evaluate the ammonia flow rate in the fuel supply line and confirm that the replacement with ammonia has been completed.

Conventionally, in order to confirm the replacement status with ammonia in the fuel supply line, it has been known to use general ammonia concentration measuring devices such as gas chromatography, infrared spectroscopic analysis, or gas detector tubes. Further, as a method for confirming ammonia concentration in a fuel device, JP 2023-95048 A discloses an ammonia fuel boiler system capable of suppressing emission of nitrogen oxides (NOx), which includes an ammonia measuring instrument for measuring residual ammonia concentration in a burner arrangement region.

### SUMMARY

However, gas chromatography or infrared spectroscopic analysis is instrumental analysis that requires utilities, and therefore installation of the measuring device is complicated, and evaluation of the ammonia flow rate requires a lot of time. Further, although gas detector tubes can perform simple analysis, it is difficult to handle high-concentration ammonia which is expected in the fuel supply line of an ammonia combustion device. Furthermore, the ammonia measuring instrument used in JP 2023-95048 A targets low-concentration ammonia which is supplied at a concentration similar to nitrogen oxides (1% or less) and used when denitrating nitrogen oxides generated in exhaust gas during combustion. Thus, conventionally, there have been problems that installation of a measuring device for confirming the replacement status with ammonia is complicated, evaluation of the ammonia flow rate requires a lot of time, and it is difficult to handle high-concentration ammonia which is expected in the fuel supply line of an ammonia combustion device.

Therefore, an object of the present disclosure is to provide an ammonia flow rate evaluation system, an ammonia fuel utilization device, and an ammonia flow rate evaluation method in which installation of a measuring device for confirming a replacement status with ammonia and an evaluation method therefor are simple, and which are capable of handling high-concentration ammonia.

An ammonia flow rate evaluation system according to the present embodiment includes: a first measurement unit to which a measurement target substance containing gaseous ammonia is supplied; a second measurement unit positioned downstream of the first measurement unit in a flow direction of the measurement target substance; and an ammonia absorption unit having an ammonia absorbent that absorbs ammonia in the measurement target substance, the ammonia absorption unit being installed between the first measurement unit and the second measurement unit and connected to the first measurement unit and the second measurement unit, in which the first measurement unit measures a pre-ammonia-absorption flow rate which is a flow rate before ammonia in the measurement target substance is absorbed by the ammonia absorption unit, the ammonia absorption unit uses the ammonia absorbent to absorb and remove ammonia from the measurement target substance that has passed through the first measurement unit, and the second measurement unit measures a post-ammonia-absorption flow rate which is a flow rate of the measurement target substance from which the ammonia has been removed.

The ammonia flow rate evaluation system may further include a suction pump which is positioned downstream of the second measurement unit in a flow direction of the measurement target substance, and sucks the measurement target substance in the second measurement unit.

The ammonia flow rate evaluation system may include a calculation unit that calculates a flow rate difference of the measurement target substance based on the pre-ammonia-absorption flow rate and the post-ammonia-absorption flow rate, and calculates an ammonia absorption amount ratio of the measurement target substance based on the pre-ammonia-absorption flow rate and the flow rate difference.

The ammonia absorbent may contain an acidic substance.

An ammonia fuel utilization device according to the present embodiment may include the ammonia flow rate evaluation system.

An ammonia flow rate evaluation method according to the present embodiment includes: a step of supplying a measurement target substance containing gaseous ammonia to a first measurement unit, and measuring a pre-ammonia-absorption flow rate of the measurement target substance at the first measurement unit; a step of using an ammonia absorbent to absorb and remove ammonia from the measurement target substance that has passed through the first measurement unit at an ammonia absorption unit having the ammonia absorbent; and a step of supplying the measurement target substance from which the ammonia has been removed to a second measurement unit, and measuring a post-ammonia-absorption flow rate of the measurement target substance at the second measurement unit.

A flow rate difference of the measurement target substance is calculated based on the pre-ammonia-absorption flow rate and the post-ammonia-absorption flow rate, and an ammonia absorption amount ratio of the measurement target substance is calculated based on the pre-ammonia-absorption flow rate and the flow rate difference.

According to the present disclosure, it is possible to provide an ammonia flow rate evaluation system, an ammonia fuel utilization device, and an ammonia flow rate evaluation method in which installation of a measuring device for confirming a replacement status with ammonia and an evaluation method therefor are simple, and which are capable of handling high-concentration ammonia.

### BRIEF DESCRIPTION OF THE DRAWINGS

FIG. 1 is a schematic diagram illustrating an ammonia flow rate evaluation system according to a first embodiment.

FIG. 2 is a schematic diagram illustrating an ammonia flow rate evaluation system according to a second embodiment.

### DESCRIPTION OF THE EMBODIMENTS

Hereinafter, some exemplary embodiments will be described with reference to the drawings. Note that dimensional ratios in the drawings are exaggerated for convenience of description and may differ from actual ratios.

### First Embodiment

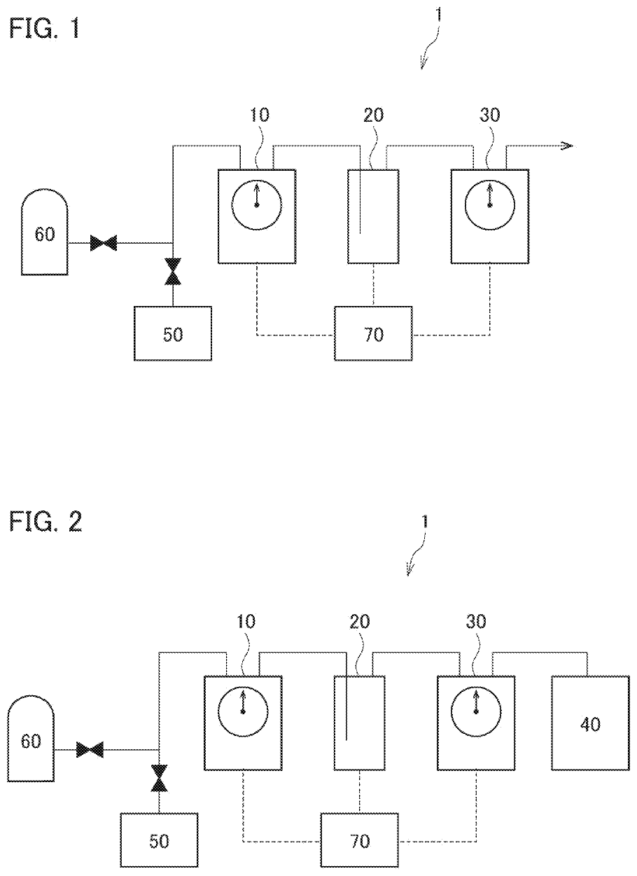

An ammonia flow rate evaluation system 1 will be described with reference to FIG. 1. The ammonia flow rate evaluation system 1 according to the present embodiment includes a first measurement unit 10 to which a measurement target substance containing gaseous ammonia is supplied. Further, the ammonia flow rate evaluation system 1 includes a second measurement unit 30 positioned downstream of the first measurement unit 10 in the flow direction of the measurement target substance. Furthermore, the ammonia flow rate evaluation system 1 includes an ammonia absorption unit 20 having an ammonia absorbent that absorbs ammonia in the measurement target substance, the ammonia absorption unit 20 being installed between the first measurement unit 10 and the second measurement unit 30 and connected to the first measurement unit 10 and the second measurement unit 30.

The first measurement unit 10 measures a pre-ammonia-absorption flow rate X_{A} which is a flow rate before ammonia in the measurement target substance is absorbed by the ammonia absorption unit 20. The first measurement unit 10 is not particularly limited as long as it is a device capable of measuring a gas flow rate, and from the viewpoint of simple installation, it is preferable that a general-purpose dry gas meter is used for the first measurement unit 10.

The ammonia absorption unit 20 uses the ammonia absorbent to absorb and remove ammonia from the measurement target substance that has passed through the first measurement unit 10. From the viewpoint of simple installation, the ammonia absorption unit 20 may include a blow-out pipe for introducing the measurement target substance into the ammonia absorbent, and a storage tank or container in which the ammonia absorbent is stored.

The ammonia absorbent is not particularly limited as long as it is a substance capable of absorbing and removing ammonia from the measurement target substance, and may contain an acidic substance. The acidic substance may be, for example, an acidic substance containing at least one selected from the group consisting of nitric acid, sulfuric acid, phosphoric acid, and hydrochloric acid. Further, the ammonia absorbent may be water. Furthermore, as the ammonia absorbent, it is also effective to employ a solid absorbent as a dry absorbent. The solid absorbent may be, for example, a porous body having a large specific surface area such as activated carbon, activated alumina, or zeolite, and may be an absorbent in which these substances are used as a carrier and impregnated with the above acidic substance.

The second measurement unit 30 measures a post-ammonia-absorption flow rate X_{B} which is a flow rate of the measurement target substance from which ammonia has been removed in the ammonia absorption unit 20. Similar to the first measurement unit 10, it is preferable that a general-purpose dry gas meter is used for the second measurement unit 30.

An ammonia supply unit 50 supplies the measurement target substance containing gaseous ammonia to the first measurement unit 10. The ammonia supply unit 50 is not particularly limited as long as it can supply the measurement target substance containing gaseous ammonia, and may be, for example, a storage tank or container in which the measurement target substance containing gaseous ammonia is stored, or may be a pipe through which the measurement target substance containing gaseous ammonia flows. Further, the ammonia supply unit 50 may be connected to a fuel supply line in a combustion device that burns ammonia. When supplying ammonia through the fuel supply line, it is necessary to replace the residual gas in the fuel supply line with ammonia so that oxygen does not remain in the fuel supply line. Therefore, by connecting the ammonia supply unit 50 to the fuel supply line, the replacement status with ammonia can be confirmed by the ammonia flow rate evaluation system 1. As described above, since the ammonia flow rate evaluation system 1 includes the first measurement unit 10, the ammonia absorption unit 20, and the second measurement unit 30, installation of the measuring device for confirming the replacement status with ammonia is simple.

When the pressure of the ammonia supply unit 50 is positive, or when the measurement target substance is supplied to the first measurement unit 10 by its own pressure, the ammonia supply unit 50 supplies the measurement target substance to the first measurement unit 10 by opening a valve of a pipe connecting the ammonia supply unit 50 and the first measurement unit 10. If the pressure of the ammonia supply unit 50 is negative, or if the measurement target substance is not supplied to the first measurement unit 10 by its own pressure, it is preferable to provide a suction pump 40 downstream of the second measurement unit 30 in the flow direction of the measurement target substance, as described later.

As illustrated in FIG. 1, the ammonia flow rate evaluation system 1 may include a pipe connected to a gas supply unit 60 between the ammonia supply unit 50 and the first measurement unit 10. From the viewpoint of safety of the ammonia flow rate evaluation system 1 and a person who performs measurement, it is preferable that the gas supply unit 60 can supply a gas that does not contain oxygen, and it is more preferable that the gas supply unit 60 can supply nitrogen. That is, it is more preferable that the gas supply unit 60 is a nitrogen supply source. The nitrogen supply source may be a pipe through which nitrogen flows, or may be a storage tank or container in which nitrogen is stored. By using the gas supply unit 60 as a nitrogen supply source, nitrogen replacement of the first measurement unit 10, the ammonia absorption unit 20, and the second measurement unit 30 can be performed before measurement, or the measurement target substance and nitrogen can be made to flow simultaneously during measurement.

The first measurement unit 10 measures a pre-ammonia-absorption flow rate X_{A} which is a flow rate before ammonia in the measurement target substance is absorbed by the ammonia absorption unit. Then, the ammonia absorption unit 20 uses the ammonia absorbent to absorb and remove ammonia from the measurement target substance that has passed through the first measurement unit 10. Further, the second measurement unit 30 measures a post-ammonia-absorption flow rate X_{B} which is a flow rate of the measurement target substance from which the ammonia has been removed.

A flow rate difference X of the measurement target substance may be calculated based on the pre-ammonia-absorption flow rate X_{A} and the post-ammonia-absorption flow rate X_{B}. Specifically, the flow rate difference X is represented by the following formula (1). That is, the flow rate difference X is calculated by the difference between the pre-ammonia-absorption flow rate X_{A} and the post-ammonia-absorption flow rate X_{B}, and indicates the ammonia absorption amount absorbed by the ammonia absorbent.

$$X = {X}_{A} - {X}_{B} \qquad ( 1 )$$

Meanwhile, an ammonia absorption amount ratio Y (%) of the measurement target substance may be calculated based on the pre-ammonia-absorption flow rate X_{A} and the flow rate difference X. Specifically, the ammonia absorption amount ratio Y is represented by the following formula (2). That is, the ammonia absorption amount ratio Y is calculated by the ratio of the flow rate difference X to the pre-ammonia-absorption flow rate X_{A}. A larger value of the ammonia absorption amount ratio Y indicates that the ammonia content contained in the gas in which the pre-ammonia-absorption flow rate X_{A} is measured is high, and that the ammonia flow rate contained in the measurement target substance is high. From the viewpoint of confirming that replacement with ammonia has been completed, the ammonia absorption amount ratio Y may be 80% or more, may be 85% or more, may be 90% or more, or may be 95% or more. Thus, in the ammonia flow rate evaluation system 1, the installation of the measuring device for confirming the replacement status with ammonia and the evaluation method therefor are simple, and the ammonia flow rate evaluation system 1 is capable of handling high-concentration ammonia which is expected in the fuel supply line of an ammonia combustion device.

$$Y ( \% ) = ( {X}_{A} - {X}_{B} ) / {X}_{A} \times 100 = X / {X}_{A} \times 100 \qquad ( 2 )$$

As described above, the ammonia absorption unit 20 uses the ammonia absorbent to absorb and remove ammonia from the measurement target substance that has passed through the first measurement unit 10. An ammonia removal rate Z (%) in the ammonia absorption unit 20 may be calculated based on an ammonia flow rate Z_{A} contained in the gas in which the pre-ammonia-absorption flow rate X_{A} is measured and an ammonia flow rate Z_{B} contained in the gas in which the post-ammonia-absorption flow rate X_{B} is measured. Specifically, the ammonia removal rate Z is represented by the following formula (3). From the viewpoint of measurement accuracy, the ammonia removal rate Z may be 80% or more, may be 85% or more, may be 90% or more, or may be 95% or more. Note that the ammonia removal rate Z can be adjusted by the amount of ammonia absorbent in the ammonia absorption unit 20 or the flow rate of the measurement target substance.

$$Z ( \% ) = ( {Z}_{A} - {Z}_{B} ) / {Z}_{A} \times 100 \qquad ( 3 )$$

In the ammonia absorption unit 20, when all ammonia is removed from the measurement target substance that has passed through the first measurement unit 10, the value of Z_{B} in the above formula (3) is 0, and thus the ammonia removal rate Z is 100%. Then, the gas in which the post-ammonia-absorption flow rate X_{B} is measured does not contain ammonia, and thus contains gas other than ammonia. That is, the flow rate difference X is the ammonia absorption amount absorbed by the ammonia absorbent and corresponds to the ammonia flow rate contained in the measurement target substance. Further, the ammonia absorption amount ratio Y indicates the ammonia concentration of the measurement target substance.

As illustrated in FIG. 1, the ammonia flow rate evaluation system 1 may include a calculation unit 70. The calculation unit 70 may calculate a flow rate difference X of the measurement target substance based on the pre-ammonia-absorption flow rate X_{A} measured by the first measurement unit 10 and the post-ammonia-absorption flow rate X_{B} measured by the second measurement unit 30. Further, the calculation unit 70 may calculate the flow rate difference X based on the difference between the pre-ammonia-absorption flow rate X_{A} and the post-ammonia-absorption flow rate X_{B} using the above formula (1). Meanwhile, the calculation unit 70 may calculate the ammonia absorption amount ratio Y of the measurement target substance based on the pre-ammonia-absorption flow rate X_{A} and the flow rate difference X. Further, the calculation unit 70 may calculate the ammonia absorption amount ratio Y (%) of the measurement target substance based on the ratio of the flow rate difference X to the pre-ammonia-absorption flow rate X_{A} using the above formula (2). Furthermore, the calculation unit 70 may calculate the ammonia removal rate Z in the ammonia absorption unit 20 based on the ammonia flow rate Z_{A} and the ammonia flow rate Z_{B} using the above formula (3).

The ammonia flow rate evaluation system 1 may include an output unit (not illustrated). The output unit may output information on the flow rate difference X, the ammonia absorption amount ratio Y, and the ammonia removal rate Z of the measurement target substance, which are calculated by the calculation unit 70. Further, the output unit may be a display device such as a liquid crystal display, a printing device such as a printer, an information communication device, or the like.

As described above, the ammonia flow rate evaluation system 1 can provide an ammonia flow rate evaluation system in which the installation of the measuring device for confirming the replacement status with ammonia and the evaluation method therefor are simple, and which is capable of handling high-concentration ammonia.

### Second Embodiment

Next, the ammonia flow rate evaluation system 1 according to a second embodiment will be described with reference to FIG. 2. The ammonia flow rate evaluation system 1 may further include a suction pump 40 compared to the ammonia flow rate evaluation system 1 according to the first embodiment. Specifically, the suction pump 40 is positioned downstream of the second measurement unit 30 in the flow direction of the measurement target substance, and sucks the measurement target substance in the second measurement unit 30. The other parts are the same as those of the ammonia flow rate evaluation system 1 according to the first embodiment, and therefore description thereof is omitted.

When the pressure of the ammonia supply unit 50 is negative, or when the measurement target substance is not supplied to the first measurement unit 10 by its own pressure, the measurement target substance can be forcibly supplied from the ammonia supply unit 50 to the first measurement unit 10 by the ammonia flow rate evaluation system 1 according to the second embodiment.

An example of an evaluation method using the ammonia flow rate evaluation system 1 according to the second embodiment will be described. First, nitrogen was supplied from the gas supply unit 60 which is a nitrogen supply source, and nitrogen replacement of the first measurement unit 10, the ammonia absorption unit 20, and the second measurement unit 30 was performed. Next, the ammonia supply unit 50 was connected to the fuel supply line of an ammonia combustion device, and a valve of a pipe connecting the ammonia supply unit 50 and the first measurement unit 10 was opened. Thereafter, the suction pump 40 was started, and sufficient replacement of the first measurement unit 10, the ammonia absorption unit 20, and the second measurement unit 30 was performed with the measurement target substance and nitrogen. Then, as a result of measuring the flow rate for 5 minutes with dry gas meters of the first measurement unit 10 and the second measurement unit 30, the pre-ammonia-absorption flow rate X_{A} was 10 L/min, and the post-ammonia-absorption flow rate X_{B} was 1 L/min. Therefore, from the above formula (1), the flow rate difference X was calculated as 9 L/min. Further, from the above formula (2), the ammonia absorption amount ratio Y was calculated as 90%.

Meanwhile, the ammonia flow rate Z_{A} contained in the gas in which the pre-ammonia-absorption flow rate X_{A} is measured was 9 L/min, and the nitrogen flow rate was 1 L/min. Further, the ammonia flow rate Z_{B} contained in the gas in which the post-ammonia-absorption flow rate X_{B} is measured was 0 L/min, and the nitrogen flow rate was 1 L/min. Therefore, from the above formula (3), the ammonia removal rate Z in the ammonia absorption unit 20 was calculated as 100%. Further, the weight of the ammonia absorbent in the ammonia absorption unit 20 increased by 34 g by the flow rate measurement for 5 minutes. This increase in weight of the ammonia absorbent corresponds to 45 L of ammonia that flowed for 5 minutes at the ammonia flow rate Z_{A} (9 L/min). Then, only ammonia was absorbed by the ammonia absorbent, and no change was observed in the nitrogen flow rate in the pre-ammonia-absorption flow rate X_{A} and the post-ammonia-absorption flow rate X_{B}.

As described above, the ammonia flow rate evaluation system 1 according to the present embodiment includes the first measurement unit 10 to which a measurement target substance containing gaseous ammonia is supplied. Further, the ammonia flow rate evaluation system 1 includes the second measurement unit 30 positioned downstream of the first measurement unit 10 in the flow direction of the measurement target substance. Furthermore, the ammonia flow rate evaluation system 1 includes the ammonia absorption unit 20 having an ammonia absorbent that absorbs ammonia in the measurement target substance, the ammonia absorption unit 20 being installed between the first measurement unit 10 and the second measurement unit 30 and connected to the first measurement unit 10 and the second measurement unit 30. Then, the first measurement unit 10 measures the pre-ammonia-absorption flow rate X_{A} which is a flow rate before ammonia in the measurement target substance is absorbed by the ammonia absorption unit 20. Further, the ammonia absorption unit 20 uses the ammonia absorbent to absorb and remove ammonia from the measurement target substance that has passed through the first measurement unit 10. Furthermore, the second measurement unit 30 measures the post-ammonia-absorption flow rate X_{B} which is a flow rate of the measurement target substance from which the ammonia has been removed. By measuring the pre-ammonia-absorption flow rate X_{A} and the post-ammonia-absorption flow rate X_{B}, the ammonia flow rate can be evaluated. Therefore, the ammonia flow rate evaluation system 1 can provide an ammonia flow rate evaluation system in which the installation of the measuring device for confirming the replacement status with ammonia and the evaluation method therefor are simple, and which is capable of handling high-concentration ammonia.

The ammonia fuel utilization device of the present embodiment may include the ammonia flow rate evaluation system 1. Examples of the ammonia fuel utilization device include an ammonia combustion device or an ammonia fuel cell.

The ammonia combustion device may be a combustion device such as a boiler that burns gaseous ammonia, or may be a combustion device that vaporizes liquid ammonia to generate gaseous ammonia and then burns the gaseous ammonia. Further, the ammonia combustion device may be a combustion device that co-fires fuel other than ammonia, such as pulverized coal or biomass fuel, with gaseous ammonia. As described above, by connecting the ammonia supply unit 50 to the fuel supply line of the ammonia combustion device, and by providing the ammonia combustion device that includes the ammonia flow rate evaluation system 1, the replacement status with ammonia in the fuel supply line can be confirmed.

Further, the ammonia fuel cell may be a fuel cell that reacts hydrogen obtained by decomposing ammonia, or may be a fuel cell that directly reacts ammonia. By connecting the ammonia supply unit 50 to the fuel supply line of the ammonia fuel cell, and by providing the ammonia fuel cell that includes the ammonia flow rate evaluation system 1, the replacement status with ammonia in the fuel supply line can be confirmed.

Thus, the ammonia fuel utilization device of the present embodiment can provide an ammonia fuel utilization device in which the installation of the measuring device for confirming the replacement status with ammonia and the evaluation method therefor are simple, and which is capable of handling high-concentration ammonia.

Next, the ammonia flow rate evaluation method according to the present embodiment will be described. The ammonia flow rate evaluation method includes a step of supplying a measurement target substance containing gaseous ammonia to the first measurement unit 10, and measuring the pre-ammonia-absorption flow rate X_{A} of the measurement target substance at the first measurement unit 10. Further, the ammonia flow rate evaluation method includes a step of using an ammonia absorbent to absorb and remove ammonia from the measurement target substance that has passed through the first measurement unit 10 at the ammonia absorption unit 20 having the ammonia absorbent. Furthermore, the ammonia flow rate evaluation method includes a step of supplying the measurement target substance from which the ammonia has been removed to the second measurement unit 30, and measuring the post-ammonia-absorption flow rate X_{B} of the measurement target substance at the second measurement unit 30.

As described above, the flow rate difference X of the measurement target substance may be calculated based on the pre-ammonia-absorption flow rate X_{A} and the post-ammonia-absorption flow rate X_{B}, and the ammonia absorption amount ratio Y of the measurement target substance may be calculated based on the pre-ammonia-absorption flow rate X_{A} and the flow rate difference X. Therefore, the ammonia flow rate evaluation method according to the present embodiment can provide an ammonia flow rate evaluation method in which the installation of the measuring device for confirming the replacement status with ammonia and the evaluation method therefor are simple, and which is capable of handling high-concentration ammonia.

Although some embodiments have been described, it is possible to modify or vary the embodiments based on the above disclosure. All components of the above embodiments and all features described in the claims may be individually extracted and combined as long as they do not contradict each other.

The present disclosure can contribute to, for example, Goal 7 “Ensure access to affordable, reliable, sustainable and modern energy for all” and Goal 13 “Take urgent action to combat climate change and its impacts” of the Sustainable Development Goals (SDGs) led by the United Nations.

The entire contents of Japanese Patent Application No. 2024-030018 (filing date: Feb. 29, 2024) are incorporated herein by reference.

What is claimed is:

1. An ammonia flow rate evaluation system comprising:
a first measurement unit to which a measurement target substance containing gaseous ammonia is supplied;
a second measurement unit positioned downstream of the first measurement unit in a flow direction of the measurement target substance; and
an ammonia absorption unit having an ammonia absorbent that absorbs ammonia in the measurement target substance, the ammonia absorption unit being installed between the first measurement unit and the second measurement unit and connected to the first measurement unit and the second measurement unit, wherein the first measurement unit measures a pre-ammonia-absorption flow rate which is a flow rate before ammonia in the measurement target substance is absorbed by the ammonia absorption unit,
the ammonia absorption unit uses the ammonia absorbent to absorb and remove ammonia from the measurement target substance that has passed through the first measurement unit, and
the second measurement unit measures a post-ammonia-absorption flow rate which is a flow rate of the measurement target substance from which the ammonia has been removed.

2. The ammonia flow rate evaluation system according to claim 1, further comprising a suction pump which is positioned downstream of the second measurement unit in a flow direction of the measurement target substance, and sucks the measurement target substance in the second measurement unit.

3. The ammonia flow rate evaluation system according to claim 1, comprising a calculation unit that calculates a flow rate difference of the measurement target substance based on the pre-ammonia-absorption flow rate and the post-ammonia-absorption flow rate, and calculates an ammonia absorption amount ratio of the measurement target substance based on the pre-ammonia-absorption flow rate and the flow rate difference.

4. The ammonia flow rate evaluation system according to claim 1, wherein the ammonia absorbent contains an acidic substance.

5. An ammonia fuel utilization device comprising the ammonia flow rate evaluation system according to claim 1.

6. An ammonia flow rate evaluation method comprising:
a step of supplying a measurement target substance containing gaseous ammonia to a first measurement unit, and measuring a pre-ammonia-absorption flow rate of the measurement target substance at the first measurement unit;
a step of using an ammonia absorbent to absorb and remove ammonia from the measurement target substance that has passed through the first measurement unit at an ammonia absorption unit having the ammonia absorbent; and
a step of supplying the measurement target substance from which the ammonia has been removed to a second measurement unit, and measuring a post-ammonia-absorption flow rate of the measurement target substance at the second measurement unit.

7. The ammonia flow rate evaluation method according to claim 6,
wherein a flow rate difference of the measurement target substance is calculated based on the pre-ammonia-absorption flow rate and the post-ammonia-absorption flow rate, and an ammonia absorption amount ratio of the measurement target substance is calculated based on the pre-ammonia-absorption flow rate and the flow rate difference.
